(19) United States
(12) Patent Application Publication
(10) Pub. No.: US 2024/0289864 A1
(43) Pub. Date: Aug. 29, 2024

(54) PROXIMITY-BASED RESTAURANT DISCOVERY APP

(71) Applicant: Cashandra Seabrook, Anderson, SC (US)

(72) Inventor: Cashandra Seabrook, Anderson, SC (US)

(21) Appl. No.: 18/588,458

(22) Filed: Feb. 27, 2024

Related U.S. Application Data
(60) Provisional application No. 63/487,156, filed on Feb. 27, 2023.

(51) Int. Cl. G06Q 30/0601; G06Q 50/12; H04W 4/021

(52) U.S. Cl. CPC G06Q 30/0631; G06Q 50/12; H04W 4/021

(57) ABSTRACT

While metadata information can be readily acquired from clicks and actions on a platform, the action may not be pertinent to customer desires. The exemplary system and method provide a platform having features to interrogate the customers of their desires and interests via games.

### RELATED APPLICATION

This patent application claims priority to, and the benefit of, U.S. Provisional Patent Application No. 63/487,156, filed Feb. 27, 2023, which is incorporated by reference herein in its entirety.

### SUMMARY

Systems and methods are disclosed for an app (also referred to herein as (FOODIESPIN PLUS) that can assist customer users in making a choice. Systems and methods are further disclosed for an app to assist business owner users in servicing customers. Customer users, after completion of registration of a customer user account, can use the app to be provided a suggestion of a local restaurant. Business owner users, after completion of registration of a business owner user account, can use the app to add their restaurant to a directory from which the customer user is suggested a local restaurant. In some embodiments, customer users and business owner users can communicate via the in-app ticketing system to facilitate customer service issue resolution.

The exemplary system and method may streamline and bridge the communication gap between customers, and foodservice business owners, and industry professionals. It may also increase digital presence and visibility. It may also increase visits and foot traffic. It may establish new community relationships while reviving lost ones. It may reduce feuding over noncommittal food options and recreational activities.

The exemplary system and method may provide a viable management system for food service business owners and industry professionals. The exemplary system and method may reward customer loyalty. The exemplary system and method may encourage accountability within the food service space and industry. The exemplary system and method may reduce the need to rely on complex marketing trends and outreach planning. The exemplary system and method may serve as an instantaneous mediator. The exemplary system and method may offer redemptive solutions to connect and eliminate unsatisfactory service. The exemplary system and method may increase business exposure and reachability.

In an aspect, a method is disclosed (e.g., for operating the app for the user), the method comprising authenticating, over a set of user interfaces, a user for an app executing on a device; at a first user interface of the app, presenting, by a processor, a first selection output comprising a first visual output, a second visual output, and a third visual output; at the first user interface, receiving, by the processor, a first selection of the presented first visual output, second visual output, or third visual output; determining, by the processor, a location parameter of the device; at a second user interface of the app, presenting, by the processor, an animated visual output that looks like a spinning wheel, wherein the animated visual output includes a plurality segments, wherein each of the plurality of segments (corresponding to themes) is dynamically generated from results of a search; at the second user interface, receiving, by the processor, a second selection of the presented animated visual output, or an associated action widget; based on the selection of the second selection, causing, the processor, a search of a database of businesses (registered with the site) based on at least the first selection as a first criterion for the search and the location parameter as a second criterion for the search (in proximity to the user) to create a set of results; receiving, by the processor, the set of results; and presenting, by the processor, the set of results.

In another aspect, a method is disclosed (for operating the app for the business entity), the method comprising: receiving, by a processor of a server, a location parameter of a registered device associated with a user; based on a selection of a selection made at the device, searching, by the processor, a database of businesses (registered with the site) based on at least a first selection made at the device as a first criterion for the search and the location parameter as a second criterion for the search (in proximity to the user) to create a set of results; wherein the first selection was made at the device by: presenting at a first user interface of the device a first selection output comprising a first visual output, a second visual output, and a third visual output; at the first user interface, receiving a first selection of the presented first visual output, second visual output, or third visual output; presenting at a second user interface of the device an animated visual output that looks like a spinning wheel, wherein the animated visual output includes a plurality segments, wherein each of the plurality of segments (corresponding to themes) is dynamically generated from results of a search; at the second user interface, receiving a second selection of the presented animated visual output, or an associated action widget; transmitting, by the processor, the set of results.

In another aspect, a system is disclosed comprising a processor; and a memory having instructions stored thereon, wherein execution of the instructions by the processor causes the processor to: authenticate, over a set of user interfaces, a user for an app executing on a system; at a first user interface of the app, present a first selection output comprising a first visual output, a second visual output, and a third visual output; at the first user interface, receive a first selection of the presented first visual output, second visual output, or third visual output; determine a location parameter of the device; at a second user interface of the app, present an animated visual output that looks like a spinning wheel, wherein the animated visual output includes a plurality segments, wherein each of the plurality of segments (corresponding to themes) is dynamically generated from results of a search; at the second user interface, receive a second selection of the presented animated visual output, or an associated action widget; based on the selection of the second selection, search a database of businesses (registered with the site) based on at least the first selection as a first criterion for the search and the location parameter as a second criterion for the search (in proximity to the user) to create a set of results; and present the set of results.

In another aspect, a non-transitory computer-readable medium is disclosed having instructions stored thereon, wherein execution of the instructions by a processor causes the processor to: authenticate, over a set of user interfaces, a user for an app executing on a system; at a first user interface of the app, present a first selection output comprising a first visual output, a second visual output, and a third visual output; at the first user interface, receive a first selection of the presented first visual output, second visual output, or third visual output; determine a location parameter of the device; at a second user interface of the app, present an animated visual output that looks like a spinning wheel, wherein the animated visual output includes a plurality segments, wherein each of the plurality of segments (corresponding to themes) is dynamically generated from results of a search; at the second user interface, receive a second selection of the presented animated visual output, or an associated action widget; based on the selection of the second selection, search a database of businesses (registered with the site) based on at least the first selection as a first criterion for the search and the location parameter as a second criterion for the search (in proximity to the user) to create a set of results; and present the set of results.

In another aspect, a method for operating is disclosed (e.g., back-end servers) a ticket resolution portal for an end user comprising authenticating, over a set of graphical user interfaces (GUI), by a processor of a user device (e.g., back-end server), a user for an app executing on the user device; presenting, by the processor of the user device, at a first GUI, a directory of businesses retrieved from a database of businesses stored on an external server, from which a selection of a business entity from the directory of businesses is chosen by the user via the app; generating, by the processor of the user device, based on the selection of the business entity chosen by the user, via a second GUI, a virtual ticket generation form for completion by the user; the virtual ticket generation form having respective fields to receive user information and sale information as ticket data; generating, by the processor of the user device, via a third GUI, based on the completion of the virtual ticket generation form, a virtual ticket object to the user, the virtual ticket object comprising a ticket number, the ticket data associated with the ticket number, and a ticket status associated with the ticket number, the ticket status being one of an open state, an in-progress state, and a closed state, the ticket status having a progression of the open state to the in-progress state and a progression of the in-progress state to the closed state; based on the progression of ticket status from the open state to the in-progress state, opening, by the processor of the user device, a two-way communication channel between the user device and a business entity device associated with the business entity; and based on the progression of ticket status from the in-progress state to the closed state, closing the two-way communication channel between the user device and the business entity device.

In some embodiments, the progression of ticket status is determined by at least one of: a selection of a virtual ticket generation app executing at the business entity device or a by a pre-defined time period (e.g., 72 hours).

In some embodiments, the two-way communication channel comprises at least one of (i) text-based communication (e.g., email or text messaging), (ii) voice communication, and (iii) video communication.

In another aspect, a method is disclosed for operating (e.g., at back-end servers) a ticket resolution portal for a business entity, the method comprising: receiving, by a processor of a server, a location parameter of a registered user device and associated with a user; issuing, by the processor of the server, and upon receipt of a completed virtual ticket registration form from the registered device, a virtual ticket object to the registered user device, the completed virtual ticket registration form having ticket data from filled data fields of user information and sale information, the virtual ticket object comprising a ticket number, ticket data associated with the ticket number, and a ticket status associated with the ticket number, wherein the ticket status includes one of a open state, an in-progress state, and a closed state, wherein the ticket status has a progression of the open state to the in-progress state and a progression of the in-progress state to the closed state; based on the progression of ticket status from the open state to the in-progress state, opening, by the processor of the server, a two-way channel of communication between the registered device and the server; and based on the progression of ticket status from the in-progress state to the closed state, closing, by the processor of the server, the two-way communication channel between the registered device and the business entity device.

In some embodiments, the progression of ticket status is determined by at least one of: a selection of a virtual ticket generation app executing at the business entity device or a by a pre-defined time period (e.g., 72 hours).

In some embodiments, the two-way communication channel comprises at least one of (i) text-based communication (e.g., email or text messaging), (ii) voice communication, and (iii) video communication.

In another aspect, a method is disclosed for operating (e.g., back-end servers) a ticket resolution portal, the method comprising: authenticating, over a set of graphical user interfaces (GUI), by a processor of a user device (e.g., back-end server), a user for an app executing on the user device; presenting, by the processor of the user device, at a first GUI, a directory of businesses retrieved from a database of businesses stored on an external server, from which a selection of a business entity from the directory of businesses is chosen by the user via the app; generating, by the processor of the user device, based on the selection of the business entity chosen by the user, via a second GUI, a virtual ticket generation form for completion by the user; the virtual ticket generation form having respective fields to receive user information and sale information as ticket data; generating, by the processor of the user device, via a third GUI, based on the completion of the virtual ticket generation form, a virtual ticket object to the user, the virtual ticket object comprising a ticket number, the ticket data associated with the ticket number, and a ticket status associated with the ticket number, the ticket status being one of an open state, an in-progress state, and a closed state, the ticket status having a progression of the open state to the in-progress state and a progression of the in-progress state to the closed state; based on the progression of ticket status from the open state to the in-progress state, opening, by the processor of the user device, a two-way communication channel between the user device and a business entity device associated with the business entity; and based on the progression of ticket status from the in-progress state to the closed state, closing the two-way communication channel between the user device and the business entity device.

In some embodiments, the progression of ticket status is determined by at least one of: a selection of a virtual ticket generation app executing at the business entity device or a by a pre-defined time period (e.g., 72 hours).

In some embodiments, the two-way communication channel comprises at least one of (i) text-based communication (e.g., email or text messaging), (ii) voice communication, and (iii) video communication.

In another aspect, a method is disclosed for operating (e.g., at back-end servers) a ticket resolution portal for a business entity, the method comprising: receiving, by a processor of a server, a location parameter of a registered user device and associated with a user; issuing, by the processor of the server, and upon receipt of a completed virtual ticket registration form from the registered device, a virtual ticket object to the registered user device, the completed virtual ticket registration form having ticket data from filled data fields of user information and sale information, the virtual ticket object comprising a ticket number, ticket data associated with the ticket number, and a ticket status associated with the ticket number, wherein the ticket status includes one of a open state, an in-progress state, and a closed state, wherein the ticket status has a progression of the open state to the in-progress state and a progression of the in-progress state to the closed state; based on the progression of ticket status from the open state to the in-progress state, opening, by the processor of the server, a two-way channel of communication between the registered device and the server; and based on the progression of ticket status from the in-progress state to the closed state, closing, by the processor of the server, the two-way communication channel between the registered device and the business entity device.

In some embodiments, the progression of ticket status is determined by at least one of: a selection of a virtual ticket generation app executing at the business entity device or a by a pre-defined time period (e.g., 72 hours).

In some embodiments, the two-way communication channel comprises at least one of (i) text-based communication (e.g., email or text-messaging), (ii) voice communication, and (iii) video communication.

### BRIEF DESCRIPTION OF THE DRAWINGS

FIG. 1 shows an example method for a platform that interfaces with a customer device and business devices in accordance with an illustrative embodiment.

FIG. 2 shows a customer operational flowchart for the platform.

FIG. 3 shows a business operational flowchart for the platform.

FIGS. 4 and 5 each shows example metadata that can be acquired via the platform for business analytics.

### DETAILED DESCRIPTION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the nth reference in the list. All references cited and discussed in this specification are incorporated herein by reference in their entirety and to the same extent as if each reference was individually incorporated by reference.

### Example System

FoodieSpin Plus, or embodiments thereof, is an interactive food service discovery and geosocial networking application system. The app utilizes location-based spinner wheels to randomly connect users to local restaurants, food vendors, eateries, bars, pubs, clubs, cinemas, theaters, amusement, and entertainment venues while providing food service professionals and industry business owners with a customer support management, monitoring system, as well as a retention ticketing database. This application system enhances hospitality, tourism, and dining experiences and encourages consumer activity.

### Potential Technical Problems Addressed by the Example System

While metadata information can be readily acquired from clicks and actions on a platform, the action may not be pertinent to customer desires. The exemplary system and method provide a platform having features to interrogate the customers of their desires and interests via games.

Typically, customers spend too much time deciding what and where they are going to eat. Although dinner is the most controversial mealtime, customers are unsure what type of food they want at what time. Customers often settle for the same familiar locations. Customers are faced with the same dilemmas when deciding on recreational activities. There is interest in understanding specific customer preferences. The exemplary system and method interrogates the customer in an indirect manner to acquire metadata of interest from the consumer.

In addition, Foodservice Business Owners and industry professionals are without a direct, viable solution to manage, monitor, and improve customer service experience and retention while personally engaging with their customers and settling disputes in-house. The exemplary system and method provide a full-service platform to acquire metadata of business interest from the consumer while providing a full back-end system to address customer service concerns.

### Example Method for Customer Operation

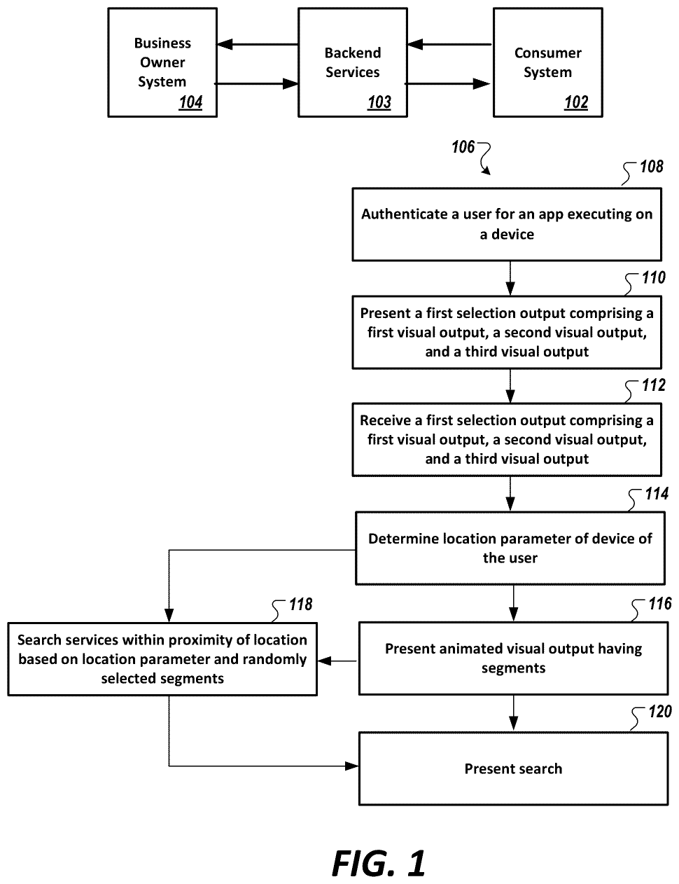

FIG. 1 shows an example system comprising a customer device 102 that operates with back-end services 103. The back-end services 103 also provide webAPI services to devices 104 of business customers. In an aspect, method 106 is disclosed to interrogate the customers of their desires and interests via games to provide a random search to the consumer that is constrained by location.

After creating and verifying an account, the system may allow the user to choose Food, Fun, or Dessert category. In some embodiments, if the Food category is selected, the user may be presented with and allowed to choose, e.g., Breakfast, Lunch, or Dinner. The system may present and receive the user's input on whether the restaurant of interest is a Fast or Full-Service option. In some embodiments, the exemplary may provide or present a wheel that can receive input from the user in the form of a Tap to spin the wheel.

In FIG. 1, the method 106 includes authenticating 108, over a set of user interfaces, a user for an app executing on a device. The authentication allows a client user id. to be identified for a given session.

The system is configured to provide a three-spinner wheel that aggregates local directory listing of food services businesses and industry professionals for three categories of interest to a business owner, namely, Food, Fun, and Dessert. The three spinner wheels use geolocation and geofencing technologies to aggregate a local directory listing of foodservice businesses and industry professionals when a specific category is randomly selected within a given radius that does not exceed 25 miles. Customers are given one, free daily spin or have the option of unlocking unlimited spins for a one-time, in-app purchase. The three spinner wheel categories are Food, Fun, and Dessert.

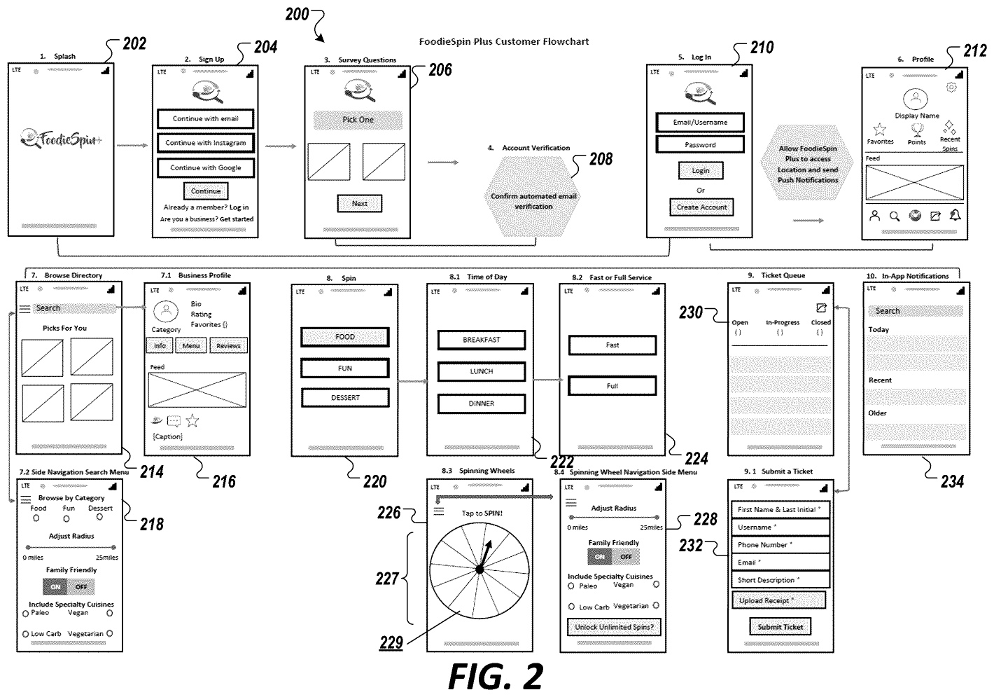

At the first user interface of the app at a user device 102, presenting (110) a first selection output comprising a first visual output, a second visual output, and a third visual output. In the example shown in FIG. 2, the first, second, and third visual outputs are shown as categories of products and/or services, e.g., of interest to the business owner. In FIG. 2, panel 220, the categories include “FOOD,” “FUN,” and “DESSERT.” Then at the first user interface at device 104, receiving (112) a first selection of the presented first visual output, second visual output, or third visual output. Additional categories can be presented to the user, including time of day (e.g., panel 222), and preference on establishment types, e.g., fast food or full service (panel 224).

To acquire the customer location, Method 106 then includes determining (114) a location parameter of the device of the user. The location can be determined based on GPS information or MPS information, readily available on a smart phone or mobile device. In some embodiments, the location parameter comprises GPS or MPS coordinates. In other embodiments, the location parameter includes landmark coordinates for a physical address to which the phone is in proximity.

To interrogate the consumer with a game at a second user interface of the app (e.g., at panel 226), method 106 includes presenting (116) an animated visual output having the aesthetic design of a spinning wheel. The animated visual output 227 includes a plurality of segments 229 in which each of the plurality of segments 229 has a corresponding to theme and is dynamically generated from the results of a search via back-end services. The segments 229 may be presented based on the user's selection per panel 220. The segments that are displayed for a selection of food may include American, Asian, Chinese, French, Greek, Japanese, Indian, Italian, Mediterranean, Mexican, Southern, and Spanish cuisines. The segments that are displayed for a section of fun may include cinema, theater, amusement park, entertainment venue, bar, club, and pub. The segments that may be displayed for a selection of desserts may include bakery, confectionery, and frozen treats.

The spinner is animated to stop at a randomly selected segment as a sub-category for the search. For food categories, e.g., with 12 segments, the random number may be selected between 1 and 12. For categories with fewer segments, the random number may be selected between 1 and the number of segments, e.g., 3, 4, 5, 6, 7, 8, 9, 10, 11, etc.

In FIG. 1, the location parameter is transmitted from the user device 102 to the backend service 103. Then, at the second user interface, e.g., panel 228, method 106 includes receiving (118) a second selection of the presented animated visual output, or an associated action widget. Based on the selection of the second selection, Method 106 can cause a search (118) of a database of businesses (registered with the site) based on at least the first selection as a first criterion for the search and the location parameter as a second criterion for the search (in proximity to the user) to create a set of result.

The back-end services 103 may perform a search that are generated based on the randomly selected subcategory, business time of operation establishment type, and user's location. An example search string can include:
<categories::sub-categories>+<time of day>+<location>

The back-end service may retrieve for each search information about the service, including a description of the services, business hours, and business type. The back-end service may filter the results based on the provided user selection.

Table 1 shows examples of example-generated strings that can be applied to a search.

TABLE 1

| | |
|---|---|
| Sel 1 (food::Greek), Sel 1 | Find Greek restaurant for breakfast near |
| (breakfast) | location |
| Sel 1 (food::Italian), Sel 2 | Find Italian restaurant for lunch near |
| (lunch) | location |
| Sel 1 (food::Indian), Sel 3 | Find Indian restaurant for dinner near |
| (dinner) | location |
| Sel 2 (Fun::cinema), Sel 1 | Find cinema opened between 8 am and |
| (breakfast) | noon near location |
| Sel 2 (Fun::pub), Sel 2 (lunch) | Find pub opened between 10 am and 2 pm |
| | near location |
| Sel 2 (Fun::club), Sel 3 | Find club opened between 2pm and 11 pm |
| (dinner) | near location |
| Sel 3 (Dessert::bakery), Sel 1 | Find bakery opened between 8 am and |
| (breakfast) | noon near location |
| Sel 3 (Dessert::frozen treats), | Find frozen treats open between 10 am |
| Sel 2 (lunch) | and 2 pm near location |

Method 106 then includes receiving the set of results and presenting (120) the results of the user, e.g., via panel 228. Panel 228 shows an example Spinner Wheel Sidebar Navigation Menu. The Spinners can be narrowed by adjusting the radius or by using filters for family-friendly environments and specialty dietary cuisines such as vegan, vegetarian, palco, and low carb.

### Example System Interface

Location: Customers must enable and allow the FoodieSpin Plus app to access their location to maximize their experience while using the app.

Customer Profile: Customers can create, edit, and personalize a free profile within an account. Customers create accounts with an email address, a nine-character password, and a username or by linking their information from existing social media or email accounts along with a username. An automated email verification request is sent to Customers to confirm their accounts. Customers can access their favorite businesses, favorite menus, recent spins, profile feed that consists of content they've “liked” or commented on, view loyalty points, user preference settings, notifications, and the help center. Customers can also interact with other Customers by replying to comments.

Survey Questions: Customers select picture choice questions before completing their accounts to better assist the app with collecting data to improve research, experience, and preferences

Browse: Any local food service business listed in the directory can be manually searched within a given radius that does not exceed 25 miles using the search bar. Searches can be narrowed by adjusting the radius, browsing foodservice business directories from the Food, Fun, and Dessert categories, or by using filters for family-friendly environments and specialty dietary cuisines such as vegan, vegetarian, palco, and low carb.

Spinner Wheels: This feature uses geolocation and geofencing technologies to aggregate a local directory of food service businesses when a specific category is randomly selected within a given radius that does not exceed 25 miles. Customers have the option of including businesses with specialty dietary cuisines or narrowing cuisine options by radius. Customers are given one free daily spin or have the option of unlocking unlimited spins for a one-time, in-app purchase of 0.99 cents.

As an example, the system may provide cuisine options for the Food category spinning wheel, including American, Asian, Chinese, French, Greck, Japanese, Indian, Italian, Mediterranean, Mexican, Southern, and Spanish cuisine choices.

As an example, the system may provide Fun category options, including cinema, theater, amusement park, entertainment venue, bar, club, and pub.

As an example, the system may provide Dessert category options, including bakery, confectionery, and frozen treats.

Ticketing Portal: Customers can submit tickets with any food service business listed within the directory and have 24 hours to report incidents. If a Customer fails to respond to an “In-Progress” ticket within 24 hours, the ticket will automatically close. Customers are required to enter their first name with their last name's initial, email address, phone number, username, and a short description of the issue and upload a receipt before submitting a ticket. Customers will receive a ticket number and can track their ticket's progress in the queue.

Directory: Customers access the food service directory by spinning or browsing. Customers can view business/meet the owner bios, operation hours, menus, ratings, reviews, and photos.

Social: Customers personally interact with food service business profile feeds by leaving ratings, reviews, and comments and “liking” their posts by tapping the flaming chili icon.

In-App Notifications: Customers have the option to enable Push Notification messages and reminders centered around popular eating times, replies to comments, personalized suggestions based on frequent searches and preferences, as well as receive updates on tickets, rewards, and local events.

Rewards: Customers have opportunities to earn loyalty points towards rewards and incentives by leaving reviews and ratings.

### Example Method of Operation for Foodservice Business Owners (FSBO) & Industry

Professionals after creating and verifying an account may (i) Choose between a basic or premium subscription, (ii) Create a business profile and unlock the customer support database and personalized, proximity-based data and insights, (iii) Receive monthly updates, and analytics to grow and sustain business Relationships; and/or (iv) Plan and implement innovative marketing and hospitality strategies based on data.

### Example Features for Foodservice Business Owners (FSBO) & Industry Professionals (IP)

Location: FSBO and professionals may enable and allow the Foodie Spin Plus app to access their location to maximize their experience while using the app Basic and Premium Accounts: FSBOs and professional may create a listing profile account in the app's directory for $9.99/month. Premium accounts are $250/month, which unlocks all other features within the app, including the customer support ticketing database, analytics dashboard with monthly updates based on personalized data, custom push notification messaging as well as the listing profile. Subscriptions can be canceled at any time. Each Owner or Professional registers their business's phone number to verify their listing using an automated system.

Survey Questions: FSBOs and professionals can select multiple choice questions before completing their accounts to better assist the app with collecting data to improve research, experience, and preferences

Profile Directory: FSBOs and professionals can create, edit, and update their professional directory that includes: a business/meet the owner bio, cuisine category, location, operation hours, menus, ratings, reviews, uploading relevant photos and videos to their feed. FSBOs and professionals can also view notifications, manage payment subscriptions, settings, tickets, and view their analytics report.

Ticketing Database: FSBOs and professionals can access the customer support management, monitoring, and retention ticketing database. When a new ticket is submitted by a customer, an owner has 72 hours to resolve the issue before being flagged by the FoodieSpin Plus app. FSBOs and Ips can update ticket statuses to In-Progress, and Solved.

Location-Based Data & Insights: The FoodSpin Plus app gathers and measures customers' activities by collecting, logging, and surveying metadata using geotagging. Data is also collected based on Customer, FSBOs, and professional activities, preferences, habits, engagement, and interactions within the app.FSBOs and professionals can manually input data and customize statistical categories.

Social: Foodservice Business Owners can interact with customers by replying to and “liking” comments via the flaming chili icon and ticket database. Foodservice Business Owners have the option of uploading business-related photos and videos to their feeds.

In-App Notifications & Custom Push Notification Messaging: FSBOs and professionals have the option to enable and receive notifications from Foodie Spin Plus. FSBOs and professionals can receive alert notifications as it relates to profiling views, monthly analytic reports, subscription information, ticket management, marketing recommendations, and general reminders.

FSBOs and professionals can have the ability to customize push notification messages, offers, coupons, and incentives to send to customers who have favorited their business.

### Example Customer Workflow

FIG. 2 shows a FoodieSpin Plus Customer Flowchart 200.

Registration of Customer User Account: A customer user can create an account for the app by registering user identification details such as an email address and username, which user identification details can alternatively be provided by linking with an existing account from other platforms, including social media, such as Instagram.

During this customer user account registration stage, the customer user is required to respond to several picture choice questions in order to assist the app in profile setup and in data collection.

Panel 202 shows an example FoodieSpin Plus Logo Splash Screen.

Panel 204 shows an example Sign Up GUI. The Customers can create free accounts with an email address, a nine-character password, and a username or by linking their information from existing Instagram accounts or email accounts along with a username.

Panel 206 shows an example of Survey Questions. The Customers can select picture choice questions before completing their accounts to better assist the app with collecting data to improve research, experience, and preferences.

Account Verification of a Customer User Account and Log In: The customer user account must be verified as a requirement to complete registration of the customer user account. An automated verification request is sent to the customer user by email, to which the customer user must respond and confirm their email address, resulting in the verification of the customer user account. The customer user account is now able to be logged into through any device using the customer user account credentials provided by the customer user at registration.

Panel 208 shows an example of Account Verification. Automated email verification requests may be sent to Customer's email to confirm their accounts after signing up.

Customer User Account Profile and Using the App: The customer user account profile acts as the main or “home” screen of the app. From this screen, the customer user can customize their profile and edit preferences. The customer user can view a list of favored businesses, recent spins done through the app, loyalty points, and profile feed. Profile feed shows content that the customer user account has interacted with via likes or comments.

The customer user can access the local business directory, which includes information on the various local restaurants in the area that have been registered into the directory through either basic or premium business owner user accounts. The customer user can access the spinner wheel to receive a suggestion of a type of local restaurant to visit.

The spinner wheel is a feature of the app exclusive to customer user accounts. The app references a directory of local restaurants based on the location of the user's device, which is used to provide suggestions to the customer user. The spinner wheel will select one of several cuisine types to suggest local restaurants from. The customer user can also narrow the selection possibilities of the spinner wheel by selecting one of the following categories prior to the spin: Food, Fun, and Dessert.

Panel 210 shows an example login. Existing FoodieSpin Plus account owners can log into other devices using the same credentials that were used at Sign Up. Access must be allowed to enable Location Services through the cellular device to access most of the app's functions.

Panel 212 shows an example Customer Profile GUI. The customer's profile can function as the home screen of the app. Customers can edit preferences and personalize their profiles. Customers can view their favorite businesses, recent spins, loyalty points, and profile feed, as well as access the spinner wheels, ticket queue, notifications, settings, and help center. Customers' profile feed consists of content they've “liked” or commented on. Loyalty points can be earned towards rewards and incentives by leaving reviews and ratings.

Panel 214 shows an example browse Directory. Customers may access the directory by spinning or browsing. Any local food service business or industry professional listed in the directory can be manually searched within a given radius that does not exceed 25 miles using the search bar.

Panel 216 shows an example Business Profile GUI. Customers can view businesses' information, such as bios, operation hours, restaurant categories, numbers of favorites, menus, ratings, and reviews, as well as the business feed.

Panel 218 shows an example Sidebar Navigation Menu. Searches can be narrowed by adjusting the radius, browsing food service business directories from the Food, Fun, and Dessert categories, using filters for family-friendly environments, or selecting specialty dietary cuisines such as vegan, vegetarian, palco, and low carb.

Panel 220 shows an example of Spin GUI. The three spinner wheels may use geolocation and geofencing technologies to aggregate a local directory listing of food service businesses and industry professionals when a specific category is randomly selected within a given radius that does not exceed 25 miles. Customers are given one free daily spin or have the option of unlocking unlimited spins for a one-time, in-app purchase. The three spinner wheel categories are Food, Fun, and Dessert.

Panel 222 shows an example of Time of Day GUI. Customers can select breakfast, lunch, or dinner and the spinner will aggregate listed businesses that fall in either of the categories.

Panel 224 shows an example of Service Options GUI. Customers can select Fast or Full-Service options. The spinner will aggregate listed businesses that fall in either category.

Panel 226 shows an example Spinner Wheel. The system may include in the spinner of multiple cuisine options. As an example, the system may present 12 cuisine options for the Food category spinner wheel, including American, Asian, Chinese, French, Greck, Japanese, Indian, Italian, Mediterranean, Mexican, Southern, and Spanish cuisines. The Fun Category options include cinema, theater, amusement park, entertainment venue, bar, club, and pub. The Dessert category options include bakery, confectionery, and frozen treats.

Panel 228 shows an example Spinner Wheel Sidebar Navigation Menu. The Spinners can be narrowed by adjusting the radius or by using filters for family-friendly environments and specialty dietary cuisines such as vegan, vegetarian, palco, and low carb.

Panel 230 shows an example Ticket Queue. Open, In-Progress, and Closed tickets can be viewed from the Ticket Queue.

Panel 232 shows an example Submit a Ticket GUI. Customers can submit tickets with any business listed within the directory and have 24-hours to report incidents. If a Customer fails to respond to an “In-Progress” ticket within 24-hours, the ticket will close. Customers are required to enter their first name with their last name's initial, email address, phone number, username, a short description of the issue, and upload a receipt before submitting a ticket. Customers will receive a ticket number and can track their ticket's progress in the queue.

Panel 234 shows an example of In-App Notifications. Customers may have the option to enable and receive Push Notification messages and reminders from Foodie Spin centered around popular eating times, personalized suggestions based on frequent searches and preferences, and receive updates on tickets, rewards, and local events.

### Business Owner Platform Workflow

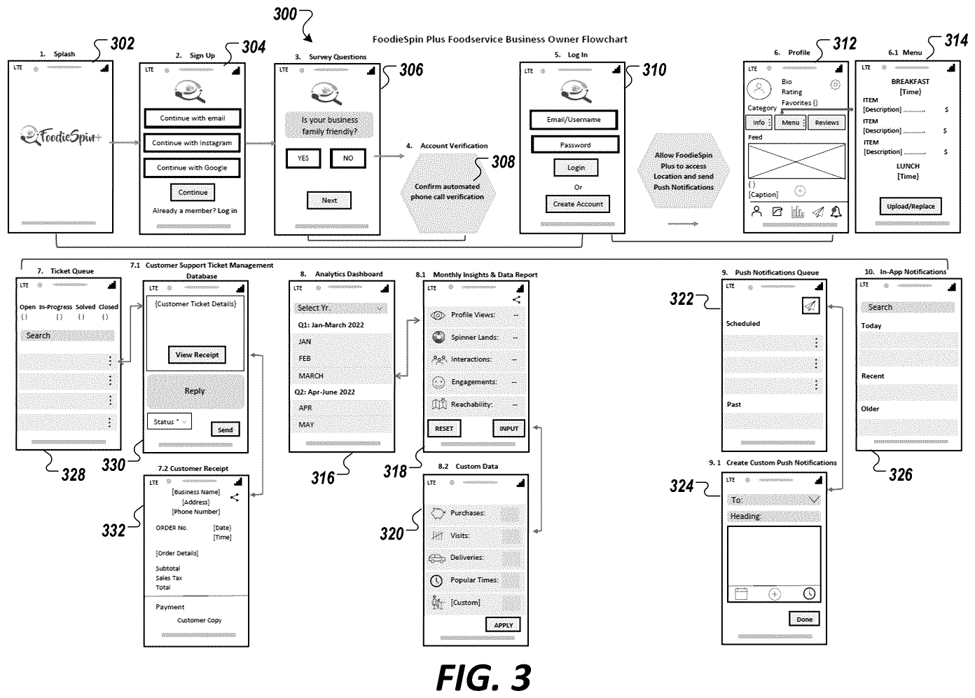

FIG. 3 shows a FoodieSpin Plus Business Flowchart.

Registration of a Business Owner User Account: A business owner user can create either a basic account for the app or a premium account for the app by providing a phone number. The basic account allows the business owner user to only list a restaurant within a directory of other local restaurants, while a premium account allows the business owner to not only list a restaurant within a directory of other local restaurants but to further unlock all additional premium features of the app, such as the use of the in-app ticketing system and monthly analytic reports.

During this business owner user account registration stage, the business owner user is required to respond to several multiple-choice questions in order to assist the app in profile set up and in data collection.

Panel 302 can also be used as the FoodieSpin Plus Logo Splash Screen.

Panel 304 shows an example Sign Up. Foodservice Business Owners and Industry Professionals can create a basic listing profile account in the app's directory. Premium accounts unlock all other features within the app, including the customer support ticketing database, analytics dashboard with monthly updates based on personalized data, custom push notification messaging as well as the listing profile.

Panel 306 shows an example of Survey Questions. The Owners and Professionals are asked multiple-choice questions before completing their accounts to better assist the app with setting up profiles and collecting data to improve research, experience, and preferences.

Account Verification of a Business Owner User Account and Log In: The business owner user must be verified as a requirement to complete registration of the business owner user account. An automated phone call verification request is sent to the business owner user, to which the business owner must respond and confirm their phone number, resulting in the verification of the business owner user account. The business owner user account is now able to be logged into through any device using the business owner user account credentials provided by the business owner user at registration.

Panel 308 shows an example of Account Verification. Owners and Professionals may register their business's phone number at Sign Up. An automated call verification request is made to the registered number to confirm the business's existence and the FoodieSpin Plus account.

The business owner's user account profile can edit their profile, which includes information on their registered local restaurant, including menus and other pertinent information. Business owner user accounts can upload pictures and videos to their feed for customer users to interact with and comment on. Premium business owner user accounts can further access the monthly analytics and reports section.

Panel 310 shows an example Log In GUI. Existing FoodieSpin Plus account owners can log into other devices using the same credentials that were used at Sign Up. Access must be allowed to enable Location Services through the cellular device to access most of the app's functions.

Panel 312 shows an example Profile GUI. Foodservice Business Owners and Industry Professionals can edit and update their bio, pertinent business information, and menus. Owners and Professionals view notifications, manage payment subscriptions, settings, and tickets, and view their analytics reports. Owners and Professionals can upload business-related photos and videos to their feeds, send custom push notification messages as well as interact with customers by replying to and liking comments.

Panel 314 shows an example Menu GUI. Owners can upload new menus, replace outdated ones or add any relevant document.

Panel 316 shows an example Analytics Dashboard. The FoodSpin Plus app can gather and measures customers' activities by collecting, logging, and surveying metadata using geotagging. Data may also be collected based on Customers, FoodService Business Owners, and Industry Professionals' activities, preferences, habits, engagement, and interactions within the app. The dashboard is categorized into four yearly quarters. Owners and Professionals can search for past insights and data by selecting a specific year.

Panel 318 shows an example of Monthly Insights & Data Report: Owners and Professionals are sent monthly insight and data reports. Owners and Professionals can share a copy to an email or print.

Panel 320 shows Custom Data GUI. Owners and Professionals can manually input data into custom presets that will be applied to the Analytics Dashboard. Customs can be discarded, and the original monthly data will be reset in the dashboard.

Panel 322 shows an example Push Notification Queue GUI. Owners and Professionals can view older push notification messages as well as compose, view, and edit scheduled push notification messages from the queue.

Panel 324 shows an example of the Create Custom Push Notifications GUI. Owners and Professionals can customize push notification messaging to send exclusive offers, coupons, and incentives to customers who have favorited their business. Owners and Professionals can send push notification messaging to a general or randomized favorites list.

Panel 326 shows an example of an In-App Notifications GUI. Owners and Professionals can enable and receive Push Notification alerts from Foodie Spin as they relate to profiling views, monthly analytic reports, subscription information, customer support ticket management, marketing recommendations, and general reminders.

In-App Ticketing System for Customer Service Issue Resolution: The app features an in-app ticketing system for the purposes of interaction between business owner users and customer users to resolve customer service issues. Customer service issues can be any issue identified by the customer user, including, but not limited to, issues with incorrect pricing or payment, meal quality, or customer service quality. Ticket statuses can include “Open,” “In-Progress,” and “Resolved.” The tickets opened by the customer user must be responded to within 72 hours by the relevant business owner user. Otherwise, the ticket will automatically be set to “Resolved” status, which closes the ticket and relevant communication channels. During the “In-Progress” status of the ticket, customer users and business owner users can communicate with each other in order to resolve the issue identified by the customer user.

Panel 328 shows an example Ticket Queue. Open, In-Progress, Solved, and Closed tickets can be viewed from the Ticket Queue.

Panel 330 shows an example Customer Support Ticket Management Database GUI. When a new ticket is submitted by a Customer, an Owner or Industry Professional has 72 hours to resolve the issue before being flagged by the FoodieSpin Plus app and the ticket is automatically closed. Owners and Professionals can update ticket statuses to In-Progress and Solved.

Panel 332 shows an example of Customer Receipt GUI. Owners and Professionals can view Customer receipts, print, or share a copy to an email.

### Metadata Aggregation

FoodieSpin Plus can integrate AI features, and semi-supervised machine learning algorithms into a database to record, monitor, and archive pertinent information collected from in-app features such as the Customer Support Ticket Management Database, spinning wheel activity, customer demographics and activities, including but not limited to selections, binary responses, filtered preferences, social engagements, and impressions. Aggregated data from preexisting sources, targets, and statistics (e.g., popular eating times, popular cuisines, ghost kitchens) within the foodservice, hospitality, tourism, and social networking industries are collected and used to train AI features and machine learning algorithms to compare and analyze its findings of preexisting data to real-time, in-app data and performance indicators, creating models and generating user activity reports and monthly insights. Corresponding data distribution is translated into visual graphs and/or charts. These results are found under default presets and/or Owners and Professionals have the ability to manually input data into custom presets that are added to the existing data and applied to the Analytics Dashboard. The database, along with its models, provides business owners and professionals with tailored, suggested goals, detected patterns, trends, predictions, and findings of new information from sources that has not been explicitly stated or considered. Business Owners and Professionals are then equipped to identify weaknesses that are negatively affecting their businesses while providing relevant, modern solutions to assist with making data-driven decisions and improvements.

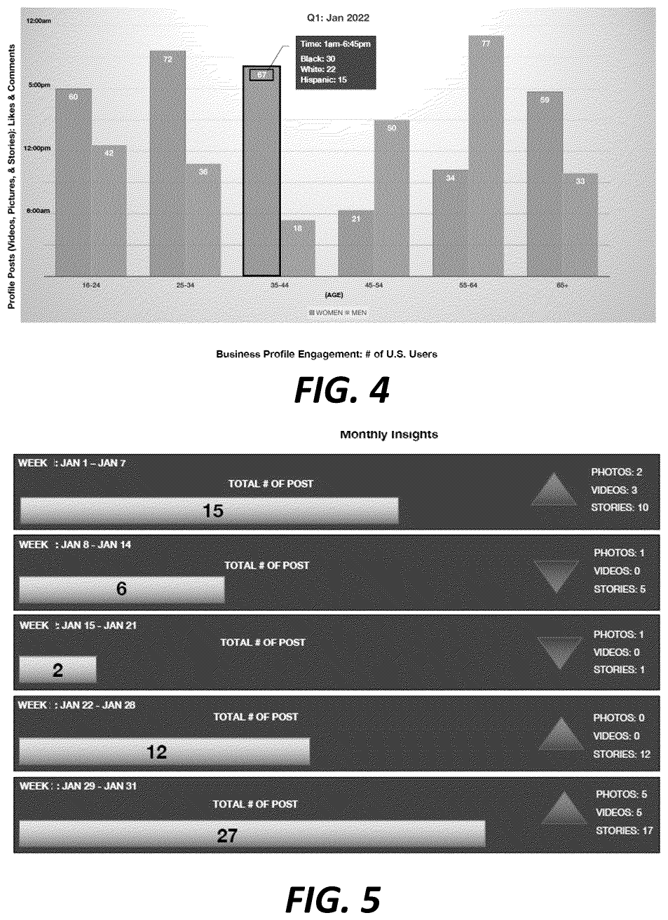

FIGS. 4 and 5 show examples of aggregation of metadata information acquired from the platform. In FIG. 4, the metadata information can be aggregated from the user profile, e.g., panel 312. FIG. 4 shows the analytics being stratified by age, demographics and time of service.

FIG. 5 shows a monthly aggregation of insights, e.g., based on social media interactions.

Example Computing System. The exemplary system and method may be implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as state operations, acts, or modules. These operations, acts, and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

The processing unit may be a standard programmable processor that performs arithmetic and logic operations necessary for the operation of the computing device. While only one processing unit is shown, multiple processors may be present. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device may also include a bus or other communication mechanism for communicating information among various components of the computing device.

The processing unit may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Example tangible, computer-readable media may include but is not limited to volatile media, non-volatile media, removable media, and non-removable media implemented in any method or technology for storage of information such as computer-readable instructions, data structures, program modules, or other data. System memory, removable storage, and non-removable storage are all examples of tangible computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In light of the above, it should be appreciated that many types of physical transformations take place in the computer architecture to store and execute the software components presented herein. It also should be appreciated that the computer architecture may include other types of computing devices, including hand-held computers, embedded computer systems, personal digital assistants, and other types of computing devices known to those skilled in the art.

In an example implementation, the processing unit may execute program code stored in the system memory. For example, the bus may carry data to the system memory, from which the processing unit receives and executes instructions. The data received by the system memory may optionally be stored on the removable storage or the non-removable storage before or after execution by the processing unit.

It must also be noted that, as used in the specification and the appended claims, the singular forms “a,” “an,” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used.

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications, and publications, as listed below and throughout this document, describes various application and systems that could be used in combination the exemplary system and are hereby incorporated by reference in their entirety herein.

What is claimed is:

1. A method comprising:
authenticating, over a set of user interfaces, a user for an app executing on a device;
at a first user interface of the app, presenting, by a processor, a first selection output comprising a first visual output, a second visual output, and a third visual output;
at the first user interface, receiving, by the processor, a first selection of the presented first visual output, second visual output, or third visual output;
determining, by the processor, a location parameter of the device;
at a second user interface of the app, presenting, by the processor, an animated visual output, wherein the animated visual output includes a plurality segments, wherein each of the plurality of segments is dynamically generated from results of a search;
at the second user interface, receiving, by the processor, a second selection of the presented animated visual output, or an associated action widget;
based on the selection of the second selection, causing, the processor, a search of a database of businesses based on at least the first selection as a first criterion for the search and the location parameter as a second criterion for the search in proximity to the user to create a set of results;
receiving, by the processor, the set of results; and
presenting, by the processor, the set of results.

2. The method of claim 1, wherein the animated visual output comprises a spinning wheel.

3. The method of claim 1, wherein the search is performed at the device.

4. The method of claim 1, wherein the search is performed on a back-end server.

5. The method of claim 1, further comprising:
providing a virtual ticket generation form.

6. The method of claim 1, further comprising:
providing two-way communication channel comprising at least one of (i) text-based communication, (ii) voice communication, and (iii) video communication with an app executing on a second device associated with a business owner.

7. A system comprising:
a processor; and
a memory having instructions stored thereon, wherein execution of the instructions by the processor causes the processor to:
authenticate, over a set of user interfaces, a user for an app executing on a system;
at a first user interface of the app, present a first selection output comprising a first visual output, a second visual output, and a third visual output;
at the first user interface, receive a first selection of the presented first visual output, second visual output, or third visual output;
determine a location parameter of the device;
at a second user interface of the app, present an animated visual output that looks like a spinning wheel, wherein the animated visual output includes a plurality segments, wherein each of the plurality of segments is dynamically generated from results of a search;
at the second user interface, receive a second selection of the presented animated visual output, or an associated action widget;
based on the selection of the second selection, search a database of businesses based on at least the first selection as a first criterion for the search and the location parameter as a second criterion for the search in proximity to the user to create a set of results; and
present the set of results.

8. The system of claim 7, wherein the animated visual output comprises a spinning wheel.

9. The system of claim 7, wherein the search is performed at the device.

10. The system of claim 7, wherein the search is performed on a back-end server.

11. The system of claim 7, wherein execution of the instructions by the processor causes the processor to:
provide a virtual ticket generation form.

12. The system of claim 7, wherein execution of the instructions by the processor causes the processor to:
provide two-way communication channel comprising at least one of (i) text-based communication, (ii) voice communication, and (iii) video communication with an app executing on a second device associated with a business owner.

13. A non-transitory computer-readable medium having instructions stored thereon, wherein execution of the instructions by a processor causes the processor to:
authenticate, over a set of user interfaces, a user for an app executing on a system;
at a first user interface of the app, present a first selection output comprising a first visual output, a second visual output, and a third visual output;
at the first user interface, receive a first selection of the presented first visual output, second visual output, or third visual output;
determine a location parameter of the device;
at a second user interface of the app, present an animated visual output that looks like a spinning wheel, wherein the animated visual output includes a plurality segments, wherein each of the plurality of segments is dynamically generated from results of a search;
at the second user interface, receive a second selection of the presented animated visual output, or an associated action widget;
based on the selection of the second selection, search a database of businesses based on at least the first selection as a first criterion for the search and the location parameter as a second criterion for the search in proximity to the user to create a set of results; and
present the set of results.

14. The non-transitory computer-readable medium of claim 13, wherein the animated visual output comprises a spinning wheel.

15. The non-transitory computer-readable medium of claim 13, wherein the search is performed at the device.

16. The non-transitory computer-readable medium of claim 13, wherein the search is performed on a back-end server.

17. The non-transitory computer-readable medium of claim 13, wherein execution of the instructions by the processor causes the processor to:
provide a virtual ticket generation form.

18. The non-transitory computer-readable medium of claim 13, wherein execution of the instructions by the processor causes the processor to:
provide two-way communication channel comprising at least one of (i) text-based communication, (ii) voice communication, and (iii) video communication with an app executing on a second device associated with a business owner.
